(19) United States
(12) Patent Application Publication
(10) Pub. No.: US 2026/0316307 A1
(43) Pub. Date: Oct. 15, 2026

(54) SCRAPER

(71) Applicant: Maya Technologies Limited, Hong Kong (CN)

(72) Inventors: Shanglin Yang, Hong Kong (CN); Siqi Zhu, Hong Kong (CN)

(21) Appl. No.: 19/719,203

(22) Filed: Jun. 25, 2026

Related U.S. Application Data
(63) Continuation-in-part of application No. 19/358,424, filed on Oct. 15, 2025, now Pat. No. 12,709,032.
Application No. 19/358,424 is a continuation of application No. 19/190,853, filed on Apr. 28, 2025, now Pat. No. 12,472,650.
Application No. 19/190,853 is a continuation-in-part of application No. 29/989,717, filed on Feb. 14, 2025, now Pat. No. D1096038.
Application No. 29/989,717 is a continuation-in-part of application No. 29/989,709, filed on Feb. 14, 2025, now Pat. No. D1126718.

(30) Foreign Application Priority Data
Apr. 1, 2025 (CN) 202520601410.5
May 26, 2026 (CN) 202620759555.2
May 26, 2026 (CN) 202630263807.8

(51) Int. Cl. B26B 5/00; A47L 13/08

(52) U.S. Cl. CPC B26B 5/003; A47L 13/08

(57) ABSTRACT

A scraper for clamping a blade may be provided. The blade may include a blade body and a cutting portion. The scraper may include a first base body and a second base body. The first base body may have a first end and a second end away from the first end. The second base body and the first base body may cooperatively clamp the blade body. The second base body is slidable relative to the first base body, the blade is slidable along with the second base body to be arranged at a retracted position or at an in-use position. When the blade is at the retracted position, the cutting portion is disposed between the first end and the second end. When th blade is at the in-use position, at least part of the cutting portion extends beyond the first end.

### CROSS REFERENCE TO RELATED APPLICATIONS

This application claims priorities of: the Chinese patent application No. 202620759555.2, filed on May 26, 2026; and the Chinese design application No. 202630263807.8, filed on May 26, 2026. Furthermore, this application is a continuation-in-part of the U.S. patent application Ser. No. 19/358,424, filed on Oct. 15, 2025. The U.S. patent application Ser. No. 19/358,424 claims the priority of the Chinese patent application No. 202520601410.5, filed on Apr. 1, 2025; and is a continuation application of the U.S. patent application Ser. No. 19/190,853, filed on Apr. 28, 2025, which is issued with the U.S. Pat. No. 12,472,650. The U.S. patent application Ser. No. 19/190,853 is a continuation-in-part of: the U.S. design application Ser. No. 29/989,717, filed on Feb. 14, 2025, which is issued with the US design No. D1096038; and the U.S. design application Ser. No. 29/989,709, filed on Feb. 14, 2025. The disclosure of the aforementioned applications are incorporated by reference herein in their entireties.

### FIELD OF THE DISCLOSURE

The present disclosure relates to the field of cutting tools, and particularly to a scraper.

### BACKGROUND

A slidable scraper may be arranged with an additional clamping structure on a slide plate to fix a blade. Therefore, the slidable scraper may have a large number of components, an assembling process of the slidable scraper may be complicated, and manufacturing costs may be high.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a scraper for clamping a blade may be provided. The blade may include a blade body and a cutting portion. The scraper may include a first base body and a second base body. The first base body may have a first end and a second end away from the first end. The second base body and the first base body may cooperatively clamp the blade body. The second base body is slidable relative to the first base body, the blade is slidable along with the second base body to be arranged at a retracted position or at an in-use position. When the blade is at the retracted position, the cutting portion is disposed between the first end and the second end. When the blade ias t the in-use position, at least part of the cutting portion extends beyond the first end.

### BRIEF DESCRIPTION OF THE DRAWINGS

Illustrative embodiments of the present disclosure are described in detail below with reference to the attached drawing figures.

FIG. 1 is a first overall structural schematic view of a scraper in some embodiments of the present disclosure, where a blade is arranged at a retracted position.

FIG. 2 is a second overall structural schematic view of the scraper in some embodiments of the present disclosure, where the blade is arranged at an in-use position.

FIG. 3 is a third overall structural schematic view of the scraper in some embodiments of the present disclosure, where the blade is arranged at a replacement position.

FIG. 4 is an exploded schematic view of the scraper in some embodiments of the present disclosure.

FIG. 5 is a fourth structural schematic view of the scraper in some embodiments of the present disclosure, where a block member is separated from the scraper.

FIG. 6 is a first overall cross-sectional view of the scraper in some embodiments of the present disclosure, where the blade is arranged at the retracted position.

FIG. 7 is a second overall cross-sectional view of the scraper in some embodiments of the present disclosure, where the blade is arranged at the in-use position.

FIG. 8 is a third overall cross-sectional view of the scraper in some embodiments of the present disclosure, where the blade is arranged at the replacement position.

FIG. 9 is a structural schematic view of a first base body in some embodiments of the present disclosure.

FIG. 10 is an overall cross-sectional view of the first base body in some embodiments of the present disclosure.

FIG. 11 is a structural schematic view of a second base body in some embodiments of the present disclosure.

FIG. 12 is a side plane view of the second base body in some embodiments of the present disclosure.

FIG. 13 is a schematic view showing the second base body being assembled to the first base body in some embodiments of the present disclosure.

FIG. 14 is a structural schematic view of a blade in another embodiment of the present disclosure.

FIG. 15 is a structural schematic view of the second base body in another embodiment of the present disclosure.

### REFERENCE NUMERALS IN THE DRAWINGS

1—blade; 10—blade body; 11—cutting portion; 12—first retaining structure; 13—second positioning structure;
2—first base body; 200—installation cavity; 2000—blade exit opening; 2001—opening; 201—first end; 202—second end; 203—first wall; 204—second wall; 205—side wall; 21—first limiting portion; 210—guide hole; 2100—first stop surface; 22—clearance groove; 23—installation notch; 24—first limiting structure; 240—limiting groove; 2401first limiting surface; 2402—second limiting surface; 2403—first limiting section; —2404—second limiting section; 2405—slope section; 251—first stop groove; 252—second stop groove; 253—third stop groove;
3—second base body; 31—second limiting portion; 310—stop member; 311—elastic member; 32—button portion; 33—mounting portion; 330—bearing surface; 331—first positioning groove; 332—second positioning protrusion; 34—second limiting structure; 340—limiting protrusion; 3400—inclined surface; 350—stop protrusion;
4—block member;
H1—protruding height of the button portion in the thickness direction; H2—protruding height of the stop member in the thickness direction; H3—protruding height of the stop protrusion in the thickness direction;
D1—distance between the first limiting section and the first wall; D2—distance between the second limiting section and the first wall.

### Detailed Description

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

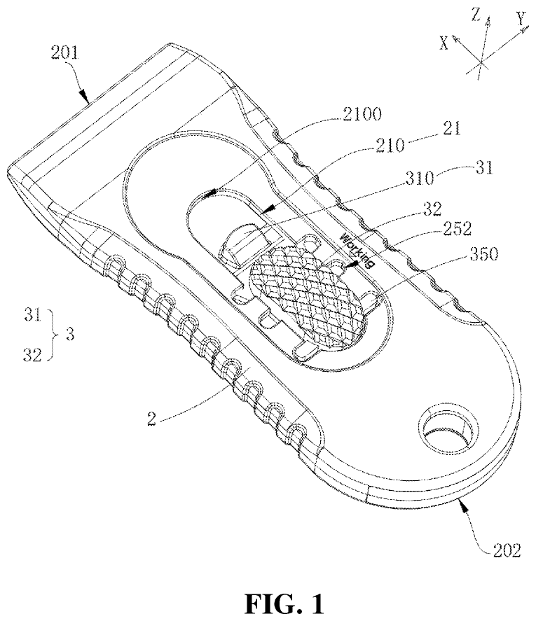

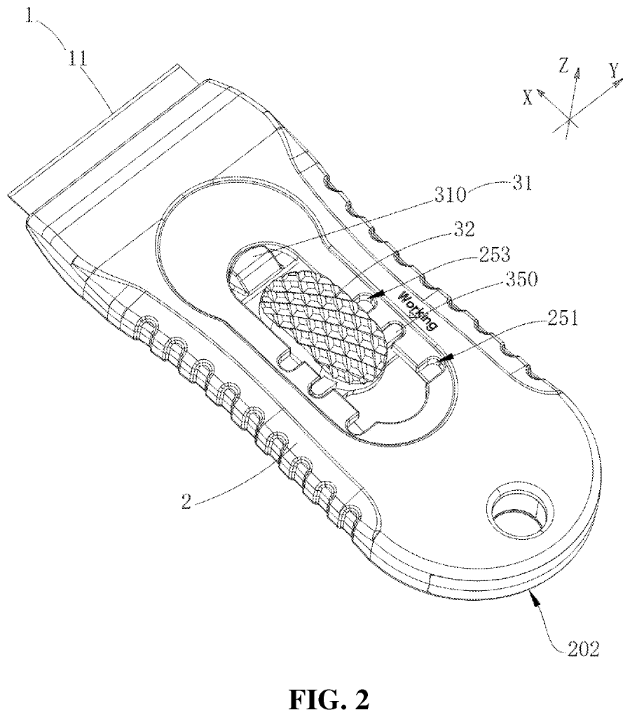

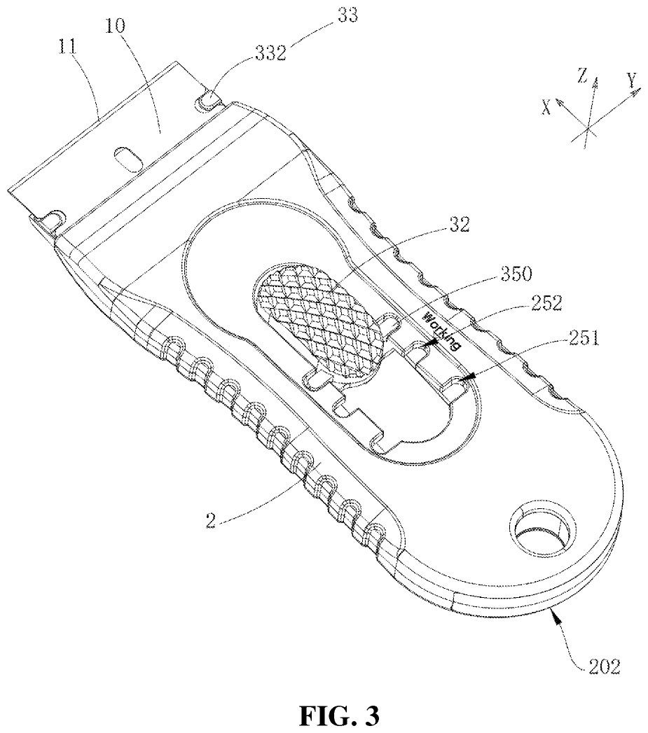

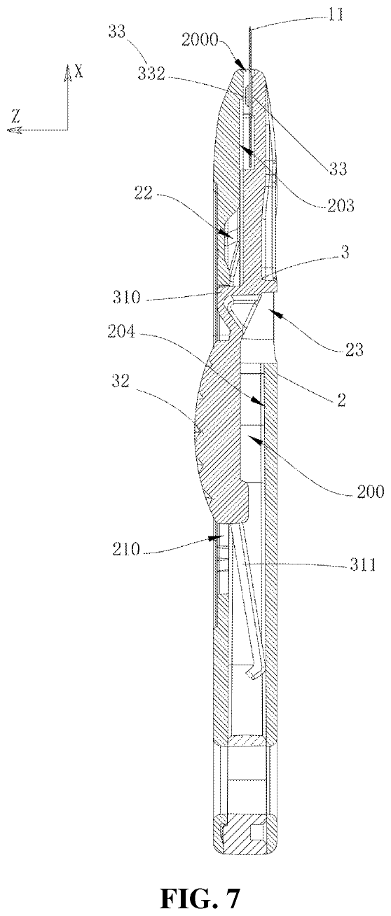

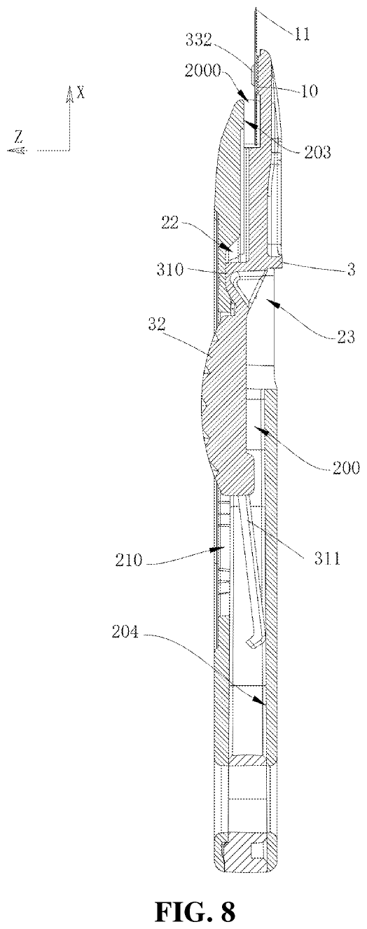

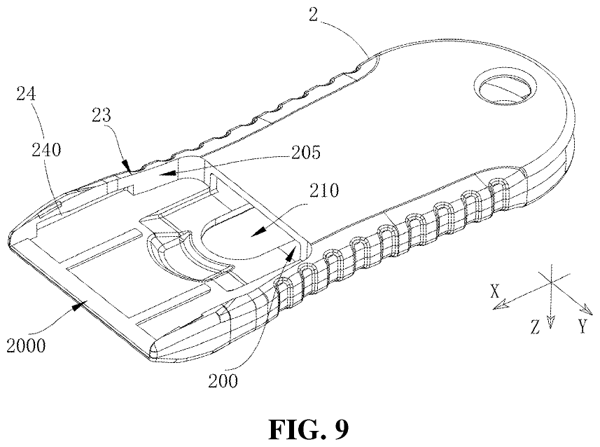

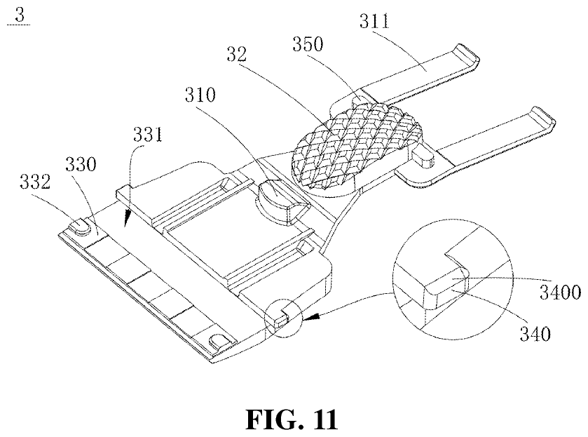

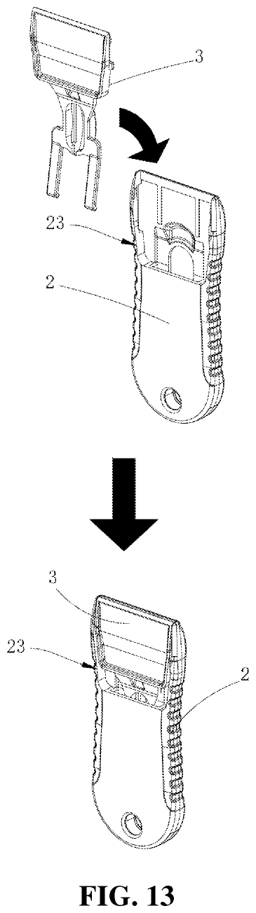

As shown in FIGS. 1-15, the present disclosure may provide a scraper for clamping a blade 1. The blade 1 may include a blade body 10 and a cutting portion 11. The scraper may include a first base body 2 and a second base body 3. The first base body 2 may have a first end 201 and a second end 202 away from the first end 201. The second base body 3 and the first base body 2 may cooperatively clamp the blade body 10. The second base body 3 may slide relative to the first base body 2. The blade 1 may be slidable as the second base body 3 slides, such that the blade 1 may be arranged at a retracted position or at an in-use position. When the blade 1 is arranged at the retracted position, the cutting portion 11 may be disposed between the first end 201 and the second end 202. When the blade 1 is arranged at the in-use position, at least part of the cutting portion 11 may extend beyond the first end 201, such as being disposed at a side of the first end 201 away from the second end 202.

Specifically, the blade 1 may be made of metal, plastic, or any other material having certain hardness. The cutting portion 11 may be a cutting edge formed at an edge of the blade body 10, or may be a scraping edge, a cutting edge, or any other s tructure arranged on one side of the blade body 10. Each of the first base body 2 and the second base body 3 may be a housing, a strip-shaped plate, or any other base structure that is slidable relative to each other and can support the blade 1. It should be understood that the scraper may have a length direction X, a width direction Y, and a thickness direction Z as shown in FIGS. 1-4. The first end 201 and the second end 202 of the first base body 2 may be opposite ends of the first base body 2 in the length direction X. The first end 201 may be a blade exit side of the scraper, and the second end 202 may be a side away from the blade exit side. The first base body 2 and the second base body 3 may be stacked in the thickness direction Z of the scraper, or one of the first base body 2 and the second base body 3 may be received in the other one of the first base body 2 and the second base body 3 in the thickness direction Z. Furthermore, the first base body 2 and the second base body 3 may be slidable relative to each other along the length direction X of the first base body 2. That is, a sliding direction may be the length direction X as shown in FIGS. 1-4. Relative sliding therebetween may be achieved through various structures. For example, the first base body 2 may be arranged with a slide groove, a snap-fit groove, a through cavity, or any other guide structure for the second base body 3 to slide. Alternatively, the first base body 2 may serve as a housing, and the second base body 3 may be slidably arranged inside the first base body 2. Alternatively, the first base body 2 and the second base body 3 may be stacked to cooperatively form a part of the housing of the scraper.

The second base body 3 may directly carry the blade body 10 and may drive the blade 1 to slide relative to the first base body 2. Alternatively, the second base body 3 may indirectly drive the blade 1 to slide by pushing the blade 1, abutting the blade 1, or snapping with the blade 1. The first base body 2 and the second base body 3 may cooperatively clamp the blade body 10, and that is, at least part of the blade body 10 may be disposed between the first base body 2 and the second base body 3 and may be limited in the thickness direction Z by the first base body 2 and the second base body 3. For example, a clamping gap adapted to a thickness of the blade body 10 may be formed between the first base body 2 and the second base body 3, such that the blade body 10 may be clamped in the clamping gap. The clamping gap may be adapted to the thickness of the blade body 10, for example, the clamping gap may be slightly greater than or equal to the thickness of the blade body 10. When elastic pressing is required, the clamping gap may be slightly less than the thickness of the blade body 10. Therefore, when the blade body 10 slides as the second base body 3 slides, the blade body 10 may not shake or may not be disengaged in the thickness direction Z. In another example, the side of the first base body 2 and/or the second base body 3 near the first end 201 may be arranged with a groove, a step, a protrusion, or a rib, or any other engaging structure. At least part of the blade body 10 may be embedded in the groove or may abut against the step, the protrusion, or the rib, such that the blade body 10 may be limited from moving, relative to the second base body 3, backward toward the second end 202. In another example, the second base body 3 may be arranged with a bearing surface for carrying the blade body 10, and a portion of the first base body 2 facing the bearing surface may press the blade body 10. When the blade body 10 is at the retracted position or the in-use position, the blade body 10 may always be at least partially maintained between the first base body 2 and the second base body 3. When the blade 1 is at the retracted position, the cutting portion 11 may be disposed between the first end 201 and the second end 202, and that is, the cutting portion 11 may not extend beyond the first end 201, the cutting portion 11 may be prevented from being exposed to an outside. When the blade 1 is in the in-use position, the second base body 3 may drive or push the blade 1 to move toward the first end 201, at least part of the cutting portion 11 may extend beyond the first end 201, allowing the user to perform a scraping or cutting operation.

In summary, according to the scraper of the present disclosure, the blade body 10 may be clamped by the first base body 2 and the second base body 3. The first base body 2 and the second base body 3 may serve as support and sliding structures of the s craper and may fix the blade 1. Compared to configuration in which an additional independent clamping member is arranged on the second base body 3, for the scraper of the present disclosure, retraction and exposing the blade 1 may be achieved, and additional components for holding the blade 1 may be reduced. Therefore, an overall structure of the scraper may be simplified, an assembling process of the scraper may be simplified, production costs may be reduced, and the blade 1 may be more stably switched between the retracted position and the in-use position.

As shown in FIGS. 1, 2, 6, 7, 10, and 11, in some embodiments, the first base body 2 may be arranged with a first limiting portion 21, and the second base body 3 may be arranged with a second limiting portion 31 capable of abutting against the first limiting portion 21. When the blade 1 is in the in-use position, the first limiting portion 21 and the second limiting portion 31 may abut against each other to limit relative sliding between the first base body 2 and the second base body 3, such that the blade 1 may be maintained in the in-use position.

Specifically, the first limiting portion 21 and the second limiting portion 31 may be structures that can abut against each other, such as protrusions, blocking walls, blocking surfaces, steps, engaging blocks, groove edges, or hole walls. The first limiting portion 21 may be arranged on an inner wall of the first base body 2, a side wall 205 of the first base body 2, an end of the first base body 2, or a path of the first base body 2 along which the second base body 3 slides. The second limiting portion 31 may be arranged on the second base body 3 and may move along with the second base body 3 relative to the first base body 2. When the second base body 3 drives the blade 1 to move from the retracted position to the first end 201 to reach the in-use position, the second limiting portion 31 may move to a position opposite to the first limiting portion 21 and may abut against the first limiting portion 21. The abutting may limit the second base body 3 from continuing sliding toward the blade exit side, preventing the cutting portion 11 from extending excessively out of the first end 201. When the blade 1 needs to be retracted from the in-use position to the retracted position, the first limiting portion 21 and the second limiting portion 31 may be disengaged from each other, or may move in a one-way avoidance manner, or may form no blocking in a reverse direction, so as to enable the second base body 3 to slide toward the second end 202. Therefore, the first limiting portion 21 and the second limiting portion 31 may not always limit the second base body 3 from driving the blade to be retracted from the in-use position to the retracted position. The first limiting portion 21 and the second limiting portion 31 may substantially limit forward sliding of the second base body 3 when the blade is at the in-use position, such that a size of the exposed blade 1 may be controlled. The blade 1 may not be excessively exposed, and therefore, unstable usage of the blade 1 or safety risks may be reduced, the scraper during use may be operated stably.

As shown in FIGS. 1, 2, 3, 6, 7, 8, 10, and 11, in some embodiments, when the abutting between the first limiting portion 21 and the second limiting portion 31 is released, the first base body 2 and the second base body 3 may be slidable relative to each other, and the blade 1 may further slide in a direction away from the second end 202 to reach a replacement position. When the blade 1 is at the replacement position, at least part of the cutting portion 11 and the blade body 10 may extend beyond the first end 201.

Specifically, the second limiting portion 31 may be a structure having an elastic deformation capability, such as an elastic protrusion, an elastic arm, an elastic button, or a stop structure arranged on an elastic support. The second limiting portion 31 may alternatively be a structure that is separatable from and movable relative to the second base body 3, such as a pressable member, a pivotable member, or a liftable member. By pressing, toggling, or elastically deforming the second limiting portion 31, the second limiting portion 31 may be disengaged from the first limiting portion 21, or the second limiting portion 31 may be disposed to avoid the first limiting portion 21, such that the abutting therebetween may be released. After the abutting is released, the second base body 3 may continue sliding relative to the first base body 2 in the direction away from the second end 202, i.e., in a direction approaching the first end 201, the second base body 3 may drive or push the blade 1 to move to the replacement position. At the replacement position, the cutting portion 11 of the blade 1 and at least part of the blade body 10 may extend beyond the first end 201. In some embodiments, most of the blade body 10 may extend beyond the first end 201, such that the blade 1 may no longer be primarily limited by being clamped between or shielded by the first base body 2 and the second base body 3. Therefore, the user may easily hold and remove the blade 1 and install a new blade 1 onto the second base body 3.

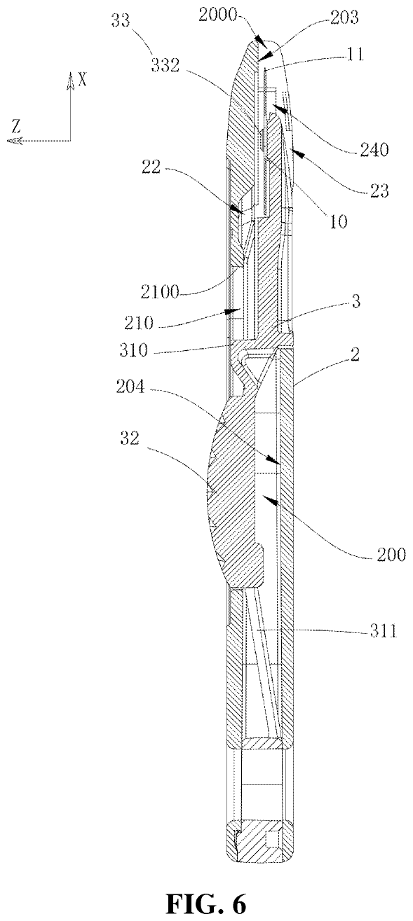

As shown in FIGS. 6-8, in some embodiments, the first base body 2 may include a first wall 203 and a second wall 204 opposite to the first wall 203. The first limiting portion 21 may include a guide hole 210 defined in the first wall 203, the guide hole 210 may be located between the first end 201 and the second end 202. The second base body 3 may be slidably disposed between the first wall 203 and the second wall 204. The second limiting portion 31 may include a stop member 310 and an elastic member 311. One end of the elastic member 311 may be connected to the second base body 3, and the other end of the elastic member 311 may abut against the second wall 204. In this way, the second base body 3 may be disposed near or in contact with the first wall 203. When the blade 1 is at the in-use position, under an action of the elastic member 311, the stop member 310 may be at least partially received in the guide hole 210 and abut against a hole wall of the guide hole 210. The stop member 310, when being pressed, may be disengaged from the guide hole 210, the second base body 3 may approach the second wall 204, and the elastic member 311 may be enabled to be stressed in an elastic potential energy loaded state. When the blade 1 is at the replacement position, the stop member 310 may be disposed between the guide hole 210 and the first end 201.

Specifically, the first wall 203 and the second wall 204 may be opposite to each other in the thickness direction Z of the scraper, and a space may be formed therebetween for the second base body 3 to slide therein. The first wall 203 may be a wall disposed near the user. The guide hole 210 may be defined in the first wall 203 and may be located between the first end 201 and the second end 202, providing a sliding and limiting space for partial components on the second base body 3. The second base body 3 may be disposed between the first wall 203 and the second wall 204 and may be slidable relative to the first base body 2 along the length direction X of the first base body 2. The stop member 310 may protrude from a side of the second base body 3 facing the first wall 203. For example, the stop member 310 may protrude from a top surface of the second base body 3. The stop member 310 may be a protrusion, a boss, a stop rib, or any other structure capable of abutting against the wall of the guide hole 210. The stop member 310 may be a non-deformable or a structure that may not be easily deformed. The elastic member 311 may be connected to the side of the second base body 3 facing the second wall 204. For example, the elastic member 311 may be connected to a bottom surface of the second base body 3 and may abut against the second wall 204. The elastic member 311 may be an elastic support, an elastic arm, an elastic sheet, or any other supportive structure capable of being elastically deformed. The elastic member 311 may abut against the second wall 204, so as to provide a supporting force toward the first wall 203 to the second base body 3. In this way, the second base body 3 may remain close to or in contact with the first wall 203 when no external force is applied, such that the stop member 310 may enter the guide hole 210 at the corresponding position. When the blade 1 is in the in-use position, the stop member 310 may be at least partially received in the guide hole 210 and may abut against a hole wall of the guide hole 210 near the first end 201, such that the second base body 3 may be limited from continuing sliding toward the first end 201. When the blade needs to be replaced, the stop member 310 may be pressed directly, or a part of the second base body 3 linked with the stop member 310 may be pressed, enabling the second base body 3 to move toward the second wall 204. The elastic member 311 may be compressed, bent, or deflected and may be in an elastic potential energy loaded state. The stop member 310 may be disengaged from the guide hole 210. Furthermore, the second base body 3 may be pushed to continue sliding toward the first end 201, the stop member 310 may pass beyond the hole wall of the guide hole 210 near the first end 201 and enter a region between the guide hole 210 and the first end 201, such that the blade 1 may be switched to the replacement position.

As shown in FIGS. 1-3 and 6-12, in some embodiments, the guide hole 210 may be elongated and may extend along the sliding direction, the first limiting portion 21 may include a first stop surface 2100 arranged in the guide hole 210, and the first stop surface 2100 may be located on the hole wall of the guide hole 210 near the first end 201. The scraper may further include a button portion 32 protruding from the second base body 3. The button portion 32 and the stop member 310 may be spaced apart from each other along the sliding direction or may be connected to each other. The button portion 32 may be at least partially received in the guide hole 210 and may slide along the extension direction of the guide hole 210. The button portion 32, when being pressed, may cause the stop member 310 to be disengaged from the guide hole 210, cause the second base body 3 to approach the second wall 204, and cause the elastic member 311 to be stressed to be in the elastic potential energy loaded state. When the blade 1 is in the retracted position, the stop member 310 may be at least partially received in the guide hole 210 and may be spaced apart from the first stop surface 2100. When the blade 1 is in the in-use position, the stop member 310 may abut against the first stop surface 2100. When the blade 1 is in the replacement position, the button portion 32 may abut against the first stop surface 2100.

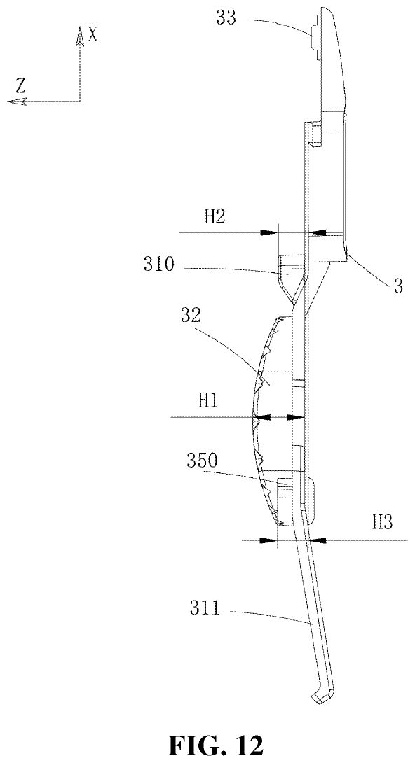

Specifically, the guide hole 210 may extend along the sliding direction in which the second base body 3 may slide relative to the first base body 2. The sliding direction may be consistent with the length direction X of the first base body 2. The button portion 32 may protrude from the side of the second base body 3 facing the first wall 203 and may be at least partially received in the guide hole 210. In this way, the user may contact the button portion 32 from an outside of the first base body 2 to push the second base body 3 to slide relative to the first base body 2. The stop member 310 and the button portion 32 may be disposed adjacent to each other along the sliding direction. The stop member 310 may be disposed closer to the first end 201 than the button portion 32 is. In some embodiments, the stop member 310 and the button portion 32 may be connected to each other or may be integrally formed as a one-piece structure. As shown in FIG. 12, a protrusion height H1 of the button portion 32 in the thickness direction Z may be greater than a protrusion height H2 of the stop member 310 in the thickness direction Z. Therefore, when the second base body 3 is pressed to approach the second wall 204, the stop member 310 may be disengaged from the guide hole 210 to enter the space between the first wall 203 and the second wall 204. At the same time, the button portion 32 may still be at least partially received in the guide hole 210. In the thickness direction Z, the button portion 32 may be substantially disposed at an opposite side to the elastic member 311. Therefore, when the user presses the button portion 32, the pressing force may be transmitted directly to the second base body 3, enabling the second base body 3 to move toward the second wall 204 and enabling the elastic member 311 to be compressed, bent, or deflected. In this way, the stop member 310 may be disengaged from the guide hole 210.

The first stop surface 2100 may be located on the hole wall of the guide hole 210 near the first end 201. When the blade 1 is in the retracted position, the stop member 310 may be at least partially received in the guide hole 210 and may be spaced apart from the first stop surface 2100. The user may push, via the button portion 32, the second base body 3 to slide toward the first end 201. When the blade 1 moves to the in-use position, the stop member 310 may abut against the first stop surface 2100 to limit the second base body 3 from continuing sliding toward the first end 201. When the blade 1 needs to be switched to the replacement position, the user may further press the button portion 32 while or before pushing the button portion 32 towards the first end 201, such that the stop member 310 may be disengaged from the guide hole 210 and may pass beyond the first stop surface 2100. Subsequently, the second base body 3 may continue moving toward the first end 201. When the blade 1 is at the replacement position, the stop member 310 may be disposed between the first wall 203 and the second wall 204 in the thickness direction Z and may be disposed between the first stop surface 2100 and the first end 201 in the sliding direction. The button portion 32 may still be at least partially received in the guide hole 210 and may abut against the first stop surface 2100 to limit the second base body 3 from continuing sliding toward the first end 201 and from being disengaged from the first base body 2.

Accordingly, by defining the elongated guide hole 210 to provide sliding guidance for the button portion 32, and by arranging the first stop surface 2100 and the stop member 310 to work cooperatively, a forward stop may be formed at the in-use position when switching from the retracted position to the in-use position, and the user may be prevented from directly pushing the blade 1 to the replacement position by performing a simple pushing action. Therefore, a risk of the blade 1 accidentally falling out or being ejected may be reduced. Further, the button portion 32 may serve as an operating portion for the user to push the second base body 3 and may serve as a press-to-unlock portion. The user may continue to push the second base body 3 to the replacement position only after pressing the button portion 32 and enabling the stop member 310 to be disengaged from the guide hole 210. Moreover, by enabling the protrusion height of the button portion 32 to be greater than the protrusion height of the stop member 310, when the blade 1 is in the replacement position, the stop member 310 may enter the space between the first wall 203 and the second wall 204 to avoid the first stop surface 2100, and the button portion 32 may still be received in the guide hole 210 and abut against the first stop surface 2100. Therefore, the second base body 3 may be limited from continuing to move forward, facilitating the second base body 3 to be prevented from detaching from the first base body 2, improving the structural stability and safety of the scraper when the scraper is in use and when the blade is being replaced.

As shown in FIGS. 6-8, in some embodiments, the first base body 2 may further include a clearance groove 22 recessed in the first wall 203. The clearance groove 22 may be located between the guide hole 210 and the first end 201. When the blade 1 is at the replacement position, the stop member 310 may be received in the clearance groove 22.

Specifically, the clearance groove 22 may be recessed in the first wall 203 and may receive the stop member 310 when the blade 1 is at the replacement position. An end of the clearance groove 22 near the guide hole 210 may have an opening, such that the stop member 310 may be received in and leave the clearance groove 22 when the blade is switching between the in-use position and the replacement position. A stop groove wall may be formed at an end of the clearance groove 22 near the first end 201. When the blade 1 is at the replacement position, the stop member 310 may abut against the stop groove wall to limit the second base body 3 from continuing to move toward the first end 201. A shape of the clearance groove 22 may be adapted to an outer contour of the stop member 310. Accordingly, the clearance groove 22 may receive the stop member 310 when the blade is at the replacement position, interference between the stop member 310 and the first wall 203 may be reduced. Furthermore, since the stop groove wall is formed at the end of the clearance groove 22 near the first end 201, the second base body 3 may be further limited from detaching from the first base body 2, and structural stability during replacing the blade may be improved.

As shown in FIGS. 1-4 and 12, in some embodiments, the second base body 3 may further be arranged with a stop protrusion 350. The stop protrusion 350 may be arranged near the button portion 32. A protrusion height H3 of the stop protrusion 350 in the thickness direction Z may be smaller than the protrusion height H2 of the stop member 310 in the thickness direction Z (as shown in FIG. 12). The first base body 2 may define a first stop groove 251, a second stop groove 252, and a third stop groove 253. The first stop groove 251, the second stop groove 252, and the third stop groove 253 may be spaced apart from each other along the sliding direction. The first stop groove 251, the second stop groove 252, and the third stop groove 253 may all be defined in the hole wall of the guide hole 210 and penetrate the first base body 2 in the thickness direction Z.

Specifically, the stop protrusion 350 may move, as the second base body 3 moves, along the extension direction of the guide hole 210. Under the elastic force of the elastic member 311, the second base body 3 may remain close to the first wall 203, such that the stop protrusion 350 may be respectively engaged in the first stop groove 251, the second stop groove 252, or the third stop groove 253. Positions at which the first stop groove 251, the second stop groove 252, and the third stop groove 253 are defined may respectively correspond to the retracted position, the in-use position, and the replacement position of the blade 1. When the blade 1 is at the retracted position, the stop protrusion 350 may be engaged in the first stop groove 251. When the blade 1 is at the in-use position, the stop protrusion 350 may be engaged in the second stop groove 252. When the blade 1 is at the replacement position, the stop protrusion 350 may be engaged in the third stop groove 253. When the user presses the button portion 32, the second base body 3 may move toward the second wall 204, enabling the stop protrusion 350 to be disengaged from the corresponding stop groove, and then the user may continue to push the button portion 32 to drive the second base body 3 and the blade 1 to switch to reach any other position. Therefore, engagement of the stop protrusion 350 with a plurality of stop grooves may enable the second base body 3 to be stably maintained at the retracted position, at the in-use position, and at the replacement position. The user must press the button portion 32 to disengage the stop protrusion 350 from the corresponding stop groove before continuing to push the second base body 3 to slide, such that position switching may be performed in a more controllable manner.

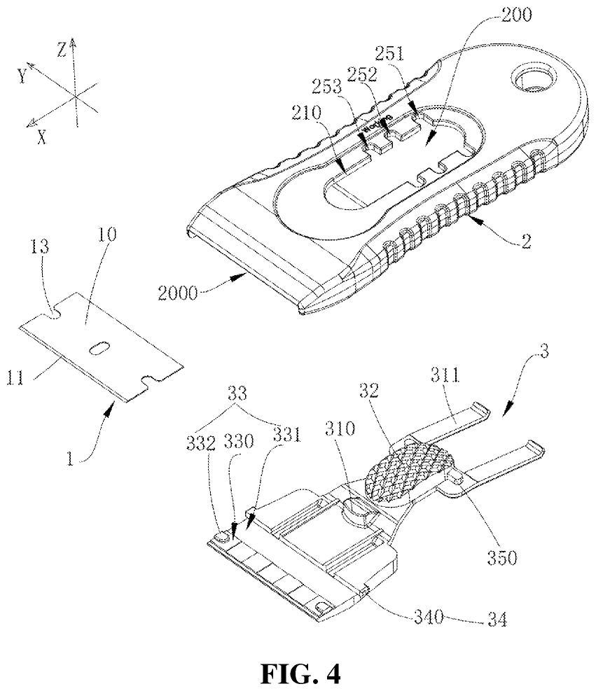

As shown in FIGS. 4, 6, 7, 8, 11, and 14, in some embodiments, the blade 1 may include a first positioning structure 12 protruding from the blade body 10 and a second positioning structure 13 recessed in the blade body 10. The first base body 2 may include the first wall 203 and the second wall 204 arranged opposite to the first wall 203. The second base body 3 may be slidably disposed between the first wall 203 and the second wall 204. The second base body 3 may include a mounting portion 33. The mounting portion 33 may include a bearing surface 330, a first positioning groove 331 recessed in the bearing surface 330, and a second positioning protrusion 332 protruding from the bearing surface 330. In the sliding direction, the first positioning groove 331 may be located between the second end 202 and the second positioning protrusion 332. The blade body 10 may be clamped by the bearing surface 330 and the first wall 203 or by the bearing surface 330 and the second wall 204. The first positioning structure 12 may be engaged in the first positioning groove 331, the second positioning structure 13 may be engaged with the second positioning protrusion 332. When the blade 1 is at the in-use position, the first positioning groove 331 and the second positioning protrusion 332 may both be located between the first end 201 and the second end 202 and may be shielded by the first wall 203 or the second wall 204. The blade 1 may be disposed at the replacement position for being replaced. When the blade 1 is at the replacement position, the second positioning protrusion 332 may not be shielded by the first wall 203 or the second wall 204.

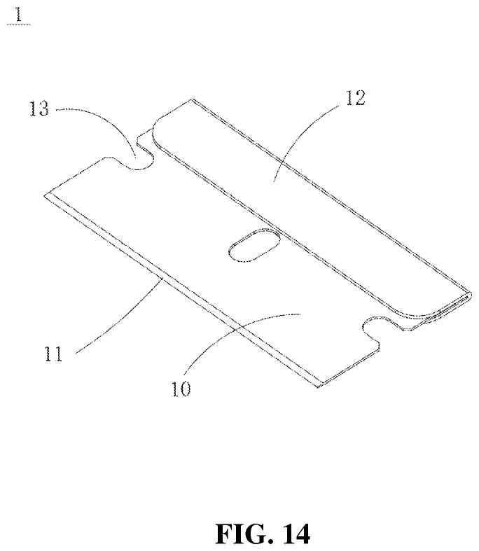

Specifically, the scraper may be adapted to a safety blade, a single-edge blade, or a similar scraping blade, i.e., the blade 1 as shown in FIG. 14. The blade 1 may generally include the blade body 10 and the cutting portion 11 forming the cutting edge. In some embodiments, the blade 1 may be arranged with a metal cladding on the side of the blade body 10 away from the cutting portion 11, such that the side may not scratch the user. The metal cladding may form the first positioning structure 12 in the present embodiment. The second positioning structure 13 may be a groove, a notch, or a through hole arranged on the blade body 10. The mounting portion 33 may be configured to carry the blade body 10, and the blade body 10 may be clamped by the bearing surface 330 and the first wall 203 or by the bearing surface 330 and the second wall 204. In the fo llowing, an example where the bearing surface 330 and the first wall 203 clamp the blade body 10 will be described. The first positioning structure 12 may be embedded in the first positioning groove 331, so as to limit the blade body 10 from moving relative to the bearing surface 330. The second positioning protrusion 332 may extend into the second positioning structure 13, so as to further limit the blade body 10 from displacing in the sliding direction (length direction X) and/or the width direction Y.

For the blade 1 having both the first positioning structure 12 and the second positioning structure 13, the first positioning groove 331 and the second positioning protrusion 332 may both work to achieve positioning. For the blade 1, which does not have the metal cladding and is arranged with only the second positioning structure 13 on the blade body 10, i.e., the blade 1 as shown in FIG. 4, positioning of the blade 1 on the bearing surface 330 may be achieved by engagement of the second positioning protrusion 332 and the second positioning structure 13. When the blade 1 is at the in-use position, the first positioning groove 331 and the second positioning protrusion 332 may both be located between the first end 201 and the second end 202 and may be shielded by the first wall 203. Therefore, it may be difficult for the blade 1 to disengage from the bearing surface 330 in the thickness direction Z. When the blade 1 is at the replacement position, the second positioning protrusion 332 may no longer be shielded by the first wall 203. In this case, for the blade 1 arranged with only the second positioning structure 13, the blade 1 may be disengaged from the second positioning protrusion 332, such that the blade 1 may be removed from the bearing surface 330 or the blade 1 may be loaded into the scraper through the bearing surface 330. For the blade 1 arranged both the first positioning structure 12 and the second positioning structure 13, since the second positioning protrusion 332, which may be a protruding structure, may not be shielded by the first wall 203, when loading the blade 1, the first positioning structure 12 may pass over the second positioning protrusion 332 to be received in the first positioning groove 331, and subsequently, the second positioning structure 13 may be engaged with the second positioning protrusion 332. In this way, loading this type of blade 1 may be completed.

Accordingly, in the present embodiment, by arranging the first positioning groove 331 and the second positioning protrusion 332 in combination, the mounting portion 33 may be adapted to various types of blades 1. The blade 1 arranged with the metal cladding and the second positioning structure 13 (as shown in FIG. 14) and the blade 1 arranged with only the second positioning structure 13 (as shown in FIG. 4) may be capable of being mounted to the mounting portion 33. Moreover, at the in-use position, the first wall 203 may shield the blade 1 and the positioning structure on the mounting portion 33, such that stability of the blade 1 after being mounted may be improved. At the replacement position, the second positioning protrusion 332 is released from shielding by the first wall 203, the blade 1 may be disengaged from the second positioning protrusion 332, and the blade 1 with the metal cladding may easily pass over the second positioning protrusion 332 to be loaded into the first positioning groove 331. In this way, the blade may be positioned reliably and may be replaced more conveniently.

As shown in FIGS. 1-13, in some embodiments, the first base body 2 may include the first wall 203 and the second wall 204 opposite to the first wall 203 in the thickness direction Z of the first base body 2. An installation cavity 200 may be formed between the first wall 203 and the second wall 204. The installation cavity 200 may have a blade exit opening 2000 at the first end 201. The first base body 2 may have the guide hole 210 defined in the first wall 203, and the guide hole 210 may communicate the installation cavity 200 with an outside of the scraper. The guide hole 210 may be elongated and may extend along the sliding direction. The second base body 3 may be slidably received in the installation cavity 200. The second base body 3 may include the button portion 32 and the mounting portion 33. The button portion 32 may at least partially extend through the guide hole 210 to be exposed to the outside via the guide hole 210. The mounting portion 33 and the first wall 203 or the mounting portion 33 and the second wall 204 may cooperatively clamp the blade body 10. When the blade 1 is at the retracted position, the cutting portion 11 may not protrude from the blade exit opening 2000; and when the blade 1 is at the in-use position, at least part of the cutting portion 11 may protrude from the blade exit opening 2000.

Specifically, the first base body 2 may serve as a housing of the scraper and may be held by the user. The first wall 203 and the second wall 204 may be opposite to each other in the thickness direction Z. The installation cavity 200 for receiving the second base body 3 and at least part of the blade 1 may be formed between the first wall 203 and the second wall 204. The first end 201 may be the blade exit side of the first base body 2, and the blade exit opening 2000 may be located at the first end 201 and may be communicated with the installation cavity 200. Therefore, the blade 1 may extend out of or retract into the installation cavity 200 through the blade exit opening 2000. The guide hole 210 may be defined in the first wall 203 and may extend along the sliding direction of the second base body 3. The sliding direction may be consistent with the length direction X of the first base body 2. The button portion 32 may at least partially extend through the guide hole 210 to be exposed to the outside via the guide hole 210. Therefore, the user may contact the button portion 32 from the outside of the first base body 2 and may push the button portion 32 to drive the second base body 3 to slide in the installation cavity 200. The mounting portion 33 may be configured to carry the blade body 10. The mounting portion 33 and the first wall 203 or the mounting portion 33 and the second wall 204 may cooperatively clamp the blade body 10. For example, when the mounting portion 33 is arranged close to the first wall 203, the mounting portion 33 and the first wall 203 may cooperatively clamp the blade body 10, such that the blade body 10 may be constrained in the thickness direction Z. When the blade 1 is at the retracted position, the cutting portion 11 may not protrude to the outside from the blade exit opening 2000, and the blade 1 may be stored in the installation cavity 200. When the blade 1 is at the in-use position, the second base body 3 may drive the blade 1 to move toward the first end 201, enabling at least part of the cutting portion 11 to protrude to the outside from the blade exit opening 2000 for scraping or cutting an object.

Accordingly, in the present embodiment, the first base body 2 may form the housing and the installation cavity 200, enabling the second base body 3 and the blade 1 to slide within the installation cavity 200 to be extended to the outside or to be retracted into the installation cavity 200. By arranging the guide hole 210 and the button portion 32 in combination, the user may operate, from the outside of the first base body 2, the second base body 3 to slide. Since the mounting portion 33 and the first wall 203 or the mounting portion 33 and the second wall 204 cooperatively clamp the blade body 10, the blade 1 may be fixed without arranging an additional independent clamping member. According to the above configuration, the blade 1 may be retracted, extended, and clamped stability, and at the same time, the number of components of the scraper may be reduced, and assembling costs may be reduced.

As shown in FIGS. 1-13, in some embodiments, the first base body 2 may further include two side walls 205 connected with the first wall 203 and the second wall 204. The first base body 2 may further define an installation notch 23 in the second wall 204. The installation notch 23 may be communicated with the installation cavity 200. An end of the installation notch 23 near the blade exit opening 2000 may be communicated with the blade exit opening 2000. The button portion 32 and the mounting portion 33 may be misaligned with each other in the thickness direction Z. The mounting portion 33 may be at least partially received in the installation notch 23. The mounting portion 33 and the first wall 203 may cooperatively clamp the blade 1.

Specifically, the two side walls 205 may be opposite to each other in the width direction Y of the first base body 2 and may be respectively connected the first wall 203 and the second wall 204. The first wall 203, the second wall 204, and the two side walls 205 may cooperatively define the installation cavity 200. The installation notch 23 may be defined in the second wall 204 and may be communicated with the installation cavity 200. The end of the installation notch 23 near the blade exit opening 2000 may be communicated with the blade exit opening 2000. Therefore, a clearance region for the mounting portion 33 to enter and slide therein may be formed at a position of the installation cavity 200 near the first end 201. The button portion 32 and the mounting portion 33 may be misaligned with each other in the thickness direction Z, such that the second base body 3 may form an operating portion and a blade-mounting portion at different heights. The button portion 32 may be located at a side near the first wall 203, enabling at least part of the button portion 32 to pass through the guide hole 210 to be exposed. The mounting portion 33 may be located at a side near the installation notch 23 and may be at least partially received in the installation notch 23. During assembly, the second base body 3 may enter the installation cavity 200 through the installation notch 23 and the blade exit opening 2000, enabling the button portion 32 to be disposed corresponding to the guide hole 210, and enabling the mounting portion 33 to be disposed corresponding to the installation notch 23. After assembly, the mounting portion 33 and the first wall 203 may cooperatively clamp the blade 1. By providing the misaligned configuration, the second base body 3 may not fully occupy the entire height between the first wall 203 and the second wall 204, such that the thickness of the first base body 2 may be reduced.

Accordingly, by defining the installation notch 23 and arranging the button portion 32 to be misaligned with the mounting portion 33 in the thickness direction Z, the second base body 3 may be assembled into the installation cavity 200 from the second wall 204 and the blade exit opening 2000 of the first base body 2, which eliminates the need for a split housing comprising separate upper and lower shells that must be fastened together. According to the above configuration, the assembling process may be simplified, an overall thickness of the scraper may be reduced, the scraper may have a more compact structure and may be light in weight, and connecting structures for assembling separated structures with each other may be reduced.

As shown in FIGS. 1-13, in some embodiments, the first wall 203, the second wall 204, and the two side walls 205 may be integrally formed with each other. Specifically, the first wall 203, the second wall 204, and the two side walls 205 may be formed by injection molding, die casting, extrusion and post-processing, or any other integral forming process. Therefore, the first base body 2 may be formed as one housing structure that cannot be split apart vertically. Since the installation notch 23 is communicated with the blade exit opening 2000, the second base body 3 may still be assembled into the installation cavity 200 through the installation notch 23 and the blade exit opening 2000. Therefore, even when the first base body 2 is formed as an integral structure, loading and sliding of the second base body 3 may not be affected. Compared to the configuration in which an upper housing and a lower housing separated from the upper housing are connected to each other via snapping or locking, in the present embodiment, additional snap-fit structures, screw posts, or locking members for connecting the upper housing and the lower housing may not be arranged on the first base body 2, the number of components of the first base body 2 may be reduced, and subsequent assembling steps may be reduced. Furthermore, a dimensional error caused by assembling separated housings with each other may be reduced. By defining the installation notch 23 providing the clearance space for assembling the second base body 3, it may be ensured that the second base body 3 may be smoothly assembled, and at the same time, molding and assembly processes of the first base body 2 may be simplified, and production costs of the scraper may be reduced.

In some embodiments, the guide hole 210 may extend in a direction toward the blade exit opening 2000. A projection of the guide hole 210 onto a first projection plane and a projection of the installation notch 23 onto the first projection plane may at least partially overlap with each other. The first projection plane may be a plane perpendicular to the thickness direction Z.

Specifically, the guide hole 210 may be defined in the first wall 203 and may extend toward the blade exit opening 2000. The installation notch 23 may be defined in the second wall 204 and may be communicated with the installation cavity 200. The first projection plane (i.e., the XY plane shown in FIGS. 1-4 and 9) may be the plane perpendicular to the thickness direction Z, and that is, when the first base body 2 is viewed from the thickness direction Z, the projection of the guide hole 210 and the projection of the installation notch 23 may at least partially overlap with each other. An overlapping region therebetween may enable the guide hole 210 and the installation notch 23 to correspond with each other in the thickness direction Z and may enable the guide hole 210 and the installation notch 23 to be communicated or nearly communicated with each other in a local region. Therefore, during a process of assembling the second base body 3 into the installation cavity 200 through the installation notch 23, the button portion 32 protruding from the second base body 3 may enter the guide hole 210 earlier without being compressed by the inner side of the first wall 203 over a long distance. In other words, the installation notch 23 may provide an entry space for the second base body 3 and the mounting portion 33, and the guide hole 210 may provide an early clearance and entry position for the button portion 32. In this way, the second base body 3 may enter the installation cavity 200 more smoothly during assembling.

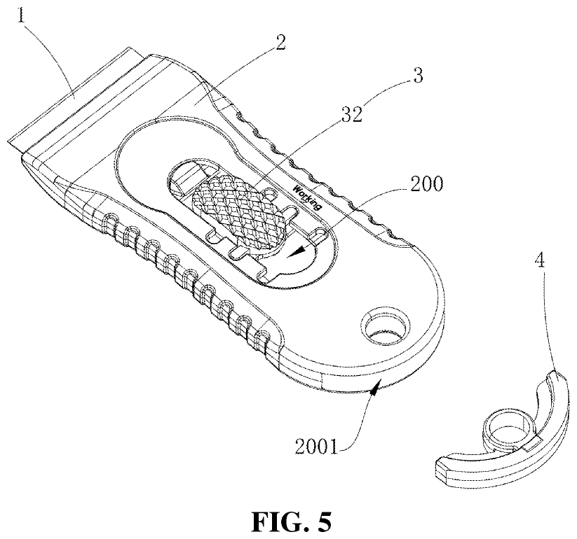

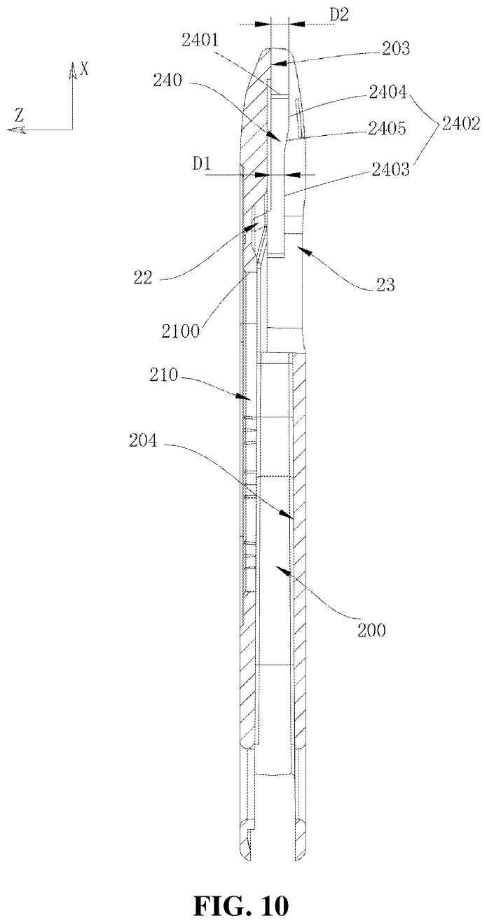

As shown in FIGS. 5 and 10, in some embodiments, the first base body 2 may be integrally formed by two opposite molding dies. The two molding dies may be inserted respectively from the first end 201 and the second end 202 of the first base body 2. In this way, the installation cavity 200 that extends through an interior of the first base body 2 from the first end 201 to the second end 202 may be formed, and the installation notch 23 communicated with the installation cavity 200 may be formed at a position near the first end 201.

Specifically, the installation cavity 200 may extend along the length direction X of the first base body 2, and the installation notch 23 may be located near the first end 201. Therefore, if only a single-side molding die is used, demolding may be performed difficultly, or local structures may not be smoothly formed. Therefore, in the present embodiment, two molding dies may be used and may be inserted respectively from the first end 201 and the second end 202 toward each other. In this way, while the first base body 2 may maintain an integral structure, the installation cavity 200 that penetrates the first base body 2 in a front-to-rear direction may be formed, and the installation notch 23 on the second wall 204 may be formed. By performing the above molding method, an opening 2001 communicated with the installation cavity 200 may be formed at the second end 202 of the first base body 2. The opening 2001 may be a process opening formed after the molding dies are withdrawn. Formation of the opening 2001 may not affect sliding of the second base body 3 relative to the first base body 2 and may not affect switching of the blade 1 among the retracted position, the in-use position, and the replacement position. Formation of the opening 2001 may enable the demolding to be performed less difficultly and may simplify the molding process of the first base body 2. Further, the scraper may further include a block member 4 arranged at the second end 202 of the first base body 2 for blocking the opening 2001. The block member 4 may be a plastic member, a rubber member, or any other blocking structure. The block member 4 may be connected to the first base body 2 by snapping, insertion, bonding, interference fit, and so on. By blocking the open opening 2001 with the block member 4, appearance integrity of the second end 202 of the first base body 2 may be improved, and entry of dust and foreign matter into the installation cavity 200 may be reduced.

As shown in FIGS. 4, 6, 7, 8, 9, 10, and 11, in some embodiments, the first base body 2 may include a first limiting structure 24 arranged on at least one of the two side walls 205, and the second base body 3 may include a second limiting structure 34 arranged on the mounting portion 33. The first limiting structure 24 and the second limiting structure 34 may be slidably engaged with each other to limit the mounting portion 33 from disengaging from the installation notch 23 in the thickness direction Z. For e xample, one of the first limiting structure 24 and the second limiting structure 34 may be a limiting groove 240 extending along the sliding direction, and the other one of the first limiting structure 24 and the second limiting structure 34 may be a limiting protrusion 340.

Specifically, the first limiting structure 24 may be arranged on at least one of the two side walls 205 of the first base body 2, and the second limiting structure 34 may be arranged on a lateral side of the mounting portion 33 in the width direction Y. The first limiting structure 24 and the second limiting structure 34 may be slidably engaged with each other when the second base body 3 slides relative to the first base body 2. The limiting groove 240 may extend along the sliding direction of the second base body 3. The limiting protrusion 340 may extend into the limiting groove 240 and slide along the limiting groove 240. In this way, the mounting portion 33 may move along with the second base body 3 in the sliding direction. Engagement of the limiting protrusion 340 and a groove wall of the limiting groove 240 may limit the mounting portion 33 from disengaging from the installation notch 23 in the thickness direction Z. One first limiting structure 24 and one second limiting structure 34 may be arranged as one set. Alternatively, one set of the first limiting structure 24 and the second limiting structure 34 may be arranged one of the two side walls 205 and one of two opposite sides of the mounting portion 33, and another set of the first limiting structure 24 and the second limiting structure 34 may be arranged on the other one of the two side walls 205 and the other one of two opposite sides of the mounting portion 33. In this way, balance and stability of the mounting portion 33 during sliding may be improved. According to the slidable engagement of the first limiting structure 24 and the second limiting structure 34, the mounting portion 33 may move in the sliding direction within the installation notch 23 but may not be disengaged from the installation notch 23 in the thickness direction Z. According to the above configuration, the mounting portion 33 may be prevented from disengaging from the first base body 2 due to formation of the installation notch 23, ensuring the blade body 10 to be stable clamped by the mounting portion 33 and the first wall 203, and improving structural reliability during the blade 1 being switched among in the retracted position, the in-use position, and the replacement position.

As shown in FIGS. 4, 6, 7, 8, 9, 10, and 11, in some embodiments, the first limiting structure 24 may include the limiting groove 240 extending along the sliding direction of the second base body 3, and the second limiting structure 34 may include the limiting protrusion 340. The limiting protrusion 340 is slidably received in the limiting groove 240. The limiting protrusion 340 may be arranged with an inclined surface 3400. The inclined surface 3400 may be configured to guide the limiting protrusion 340 to be received into the limiting groove 240 when the limiting protrusion 340 is engaged into the limiting groove 240 from the installation notch 23 in the thickness direction Z. Furthermore, or alternatively, the inclined surface 3400 may be configured to guide the limiting protrusion 340 to be received into the limiting groove 240 when the limiting protrusion 340 is engaged into the limiting groove 240 from the blade exit opening 2000 along the sliding direction.

Specifically, the limiting groove 240 may be formed on an inner side of the side wall 205 and may extend along the sliding direction of the second base body 3. The limiting protrusion 340 may protrude from the lateral side of the mounting portion 33 in the width direction Y and may extend into the limiting groove 240. After the limiting protrusion 340 engages with the limiting groove 240, the limiting protrusion 340 may slide along the limiting groove 240, allowing the second base body 3 to slide relative to the first base body 2 and limiting the mounting portion 33 from disengaging from the installation notch 23 in the thickness direction Z. The inclined surface 3400 may be disposed on a side of the limiting protrusion 340 near the limiting groove 240 or on a front side of the limiting protrusion 340 in an assembling direction. When assembling the second base body 3, the limiting protrusion 340 may be pressed into the limiting groove 240 from the installation notch 23 along the thickness direction Z, or may be pushed into the limiting groove 240 from the blade exit opening 2000 along the sliding direction. During the above assembly process, the inclined surface 3400 may contact a corresponding edge of the first base body 2 or a groove edge of the limiting groove 240, so as to guide the limiting protrusion 340 to gradually enter the limiting groove 240, such that hard interference may be reduced.

As shown in FIGS. 4, 6, 7, 8, 9, 10, and 11, in some embodiments, the limiting groove 240 may include a first limiting surface 2401, the first limiting surface 2401 may be located at an end of the limiting groove 240 near the blade exit opening 2000. The first limiting surface 2401 may be substantially perpendicular to the first wall 203. The limiting protrusion 340 may abut against the first limiting surface 2401. In this way, the limiting protrusion 340 may be limited from disengaging from the limiting groove 240 along the sliding direction.

Specifically, the limiting groove 240 may extend along the sliding direction of the second base body 3, and the first limiting surface 2401 may be formed at the end of the limiting groove 240 near the blade exit opening 2000. The first limiting surface 2401 may be a groove wall at the end of the limiting groove 240 and may be substantially perpendicular to the first wall 203, such that the first limiting surface 2401 may provide an end stopping for the limiting protrusion 340. After the second base body 3 is assembled to the first base body 2, the limiting protrusion 340 may be received in the limiting groove 240 and may be slidable along the limiting groove 240. When the limiting protrusion 340 moves toward the blade exit opening 2000 to reach the end of the limiting groove 240, the limiting protrusion 340 may abut against the first limiting surface 2401, such that the limiting protrusion 340 may be limited from continuing disengaging from the limiting groove 240 along the sliding direction. Since the first limiting surface 2401 is substantially perpendicular to the first wall 203, unlike what the inclined surface does, the first limiting surface 2401 may not guide the limiting protrusion 340 to exit the limiting groove 240. Therefore, without requiring tools or without applying a large disassembly force, the limiting protrusion 340 may be easily disengaged out of the limiting groove 240 from the end near the blade exit opening 2000. Therefore, the above configuration may be suitable for a one-time assembly or a structure that cannot be easily disassembled. A risk of accidental disengagement of the second base body 3 from the first base body 2 during use may be reduced, and overall structural stability and reliability of the scraper may be improved.

As shown in FIGS. 4, 6, 7, 8, 9, 10, and 11, in some embodiments, the limiting groove 240 may further include a second limiting surface 2402. The second limiting surface 2402 may face the first wall 203. Abutting engagement of the limiting protrusion 340 with the limiting groove 240 may include abutting engagement of the limiting protrusion 340 with the second limiting surface 2402, such that the second base body 3 may be limited from disengaging from the first base body 2 through the installation notch 23 in the thickness direction Z.

Specifically, the second limiting surface 2402 may be located on a side of the limiting groove 240 away from the first wall 203 in the thickness direction Z, and may be configured to limit the limiting protrusion 340 in the thickness direction Z, such that the second base body 3 may be prevented from disengaging from the first base body 2 through the installation notch 23. The second limiting surface 2402 may include a first limiting section 2403, a second limiting section 2404, and a slope section 2405 connected with the first limiting section 2403 and the second limiting section 2404. The first limiting section 2403 may be disposed farther from the blade exit opening 2000 than the second limiting section 2404 is. The second limiting section 2404 may be disposed closer to the blade exit opening 2000 than the first limiting section 2403 is. As shown in FIG. 10, a distance D1 between the first limiting section 2403 and the first wall 203 may be smaller than a distance D2 between the second limiting section 2404 and the first wall 203. When the blade 1 is at the retracted position or the in-use position, the limiting protrusion 340 may abut against the first limiting section 2403. At this moment, a gap between the bearing surface 330 of the second base body 3 and the first wall 203 may be relatively small, such that the blade body 10 may be more stably clamped between the bearing surface 330 and the first wall 203. When the blade 1 is at the replacement position, the limiting protrusion 340 may slide to abut against the second limiting section 2404. At this moment, the gap between the bearing surface 330 and the first wall 203 may be relatively increased, facilitating the blade body 10 to be removed from or loaded to the bearing surface 330. The slope section 2405 may serve as a transition guide during the limiting protrusion 340 switching from the first limiting section 2403 to the second limiting section 2404 or switching from the second limiting section 2404 to the first limiting section 2403, and jamming during switching may be reduced.

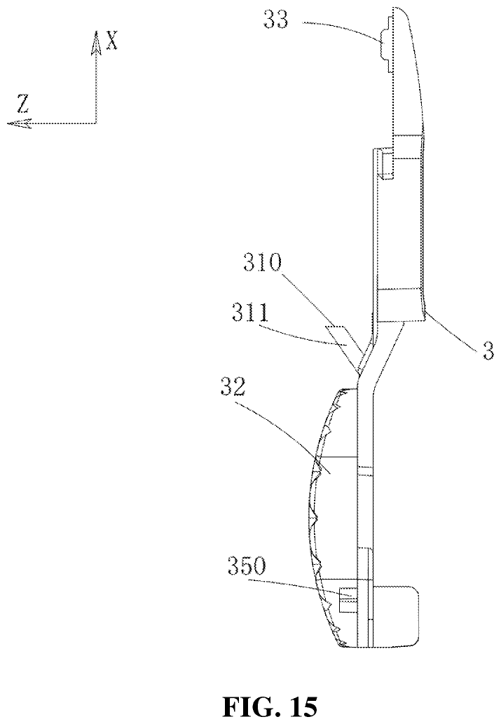

As shown in FIGS. 10 and 15, in some embodiments, the first base body 2 may include the first wall 203 and the second wall 204 arranged opposite to the first wall 203. The first limiting portion 21 may include the guide hole 210 defined in the first wall 203. The guide hole 210 may be disposed between the first end 201 and the second end 202. The second base body 3 may be slidably disposed between the first wall 203 and the second wall 204. The second limiting portion 31 may include the stop member 310 and the elastic member 311, and the stop member 310 may be connected to the second base body 3 via the elastic member 311. When the blade 1 is at the in-use position, under the action of the elastic member 311, the stop member 310 may be at least partially received in the guide hole 210 and may abut against the hole wall of the guide hole 210. The stop member 310, when pressed in the direction toward the second wall 204, may be disengaged from the guide hole 210, causing the elastic member 311 to be stressed in the elastic potential energy loaded state. When the blade 1 is at the replacement position, the stop member 310 may be disposed between the guide hole 210 and the first end 201.

Specifically, the present embodiment may be another implementation of the second limiting portion 31. The first wall 203 and the second wall 204 may be opposite to each other in the thickness direction Z. The second base body 3 may be slidably disposed between the first wall 203 and the second wall 204. The second limiting portion 31 may be an elastic arm that springs up from the second base body 3 toward the first wall 203. A body of the elastic arm may form the elastic member 311, and a free end of the elastic arm may form the stop member 310. The elastic arm may extend from the second base body 3 toward the mounting portion 33, enabling the free end to enter the guide hole 210 at the corresponding position. When the blade 1 is at the in-use position, the stop member 310, under its own elastic force, may at least partially extend into the guide hole 210 and may abut against the hole wall of the guide hole 210 near the first end 201, such that the second base body 3 may be limited from continuing sliding toward the first end 201. When the blade 1 needs to slide to the replacement position, the stop member 310 may be pressed toward the second wall 204, enabling the elastic arm to be elastically bent to be in the elastic potential energy loaded state, and the stop member 310 may be disengage from the guide hole 210. Furthermore, the second base body 3 may be further pushed, the stop member 310 may pass beyond the hole wall of the guide hole 210 near the first end 201 and may to reach a position between the guide hole 210 and the first end 201. A spring-up direction of the elastic arm may enable the second limiting portion 31 to be smoothly inserted into the guide hole 210 when the blade 1 returns from the replacement position to the in-use position.

According to the above, the elastic arm itself may form the elastic member 311, and the free end of the elastic arm may form the stop member 310. Therefore, limiting at the in-use position and press-to-unlock may be achieved without arranging an additional independent elastic support. Accordingly, structural hierarchy of the second limiting portion 31 may be reduced, the second limiting portion 31 and the second base body 3 may form a more compact one-piece engagement. At the same time, limitation in excessive extension of the blade 1 at the in-use position may still be achieved, and the blade 1 may enter the replacement position after pressing the elastic arm. Therefore, structural simplification and convenient blade replacement may both be achieved.

According to the present disclosure, the first base body and the second base body may cooperatively clamp the blade body. The first base body and the second base body may serve as support structures and slidable engagement structures for the scraper, and at the same time, may be used for fixing the blade. Compared to a configuration in which an additional independent clamping member is arranged on the second base body, for the scraper of the present disclosure, in addition to achieving retraction and extension of the blade, additional components for clamping the blade may be reduced. The overall structure and assembly processes of the scraper may be simplified, production costs may be reduced, and stability of the blade when switching between the retracted position and the in-use position may be improved.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

What is claimed is:

1. A scraper for clamping a blade, the blade comprising a blade body and a cutting portion; the scraper comprising:
a first base body, having a first end and a second end away from the first end;
a second base body, wherein the second base body and the first base body cooperatively clamp the blade body, the second base body is slidable relative to the first base body, the blade is slidable along with the second base body to be arranged at a retracted position or at an in-use position;
wherein:
when the blade is at the retracted position, the cutting portion is disposed between the first end and the second end; and
when the blade is at the in-use position, at least part of the cutting portion extends beyond the first end.

2. The scraper according to claim 1, wherein:
the first base body is arranged with a first limiting portion;
the second base body is arranged with a second limiting portion capable of abutting against the first limiting portion; and
when the blade is at the in-use position, the first limiting portion and the second limiting portion abut against each other to limit relative sliding between the first base body and the second base body to enable the blade to be maintained at the in-use position.

3. The scraper according to claim 2, wherein:
when abutment between the first limiting portion and the second limiting portion is released, the first base body and the second base body are slidable relative to each other, and the blade is capable of sliding in a direction away from the second end to reach a replacement position; and
when the blade is at the replacement position, the cutting portion and at least part of the blade body extend beyond the first end.

4. The scraper according to claim 3, wherein:
the first base body comprises a first wall and a second wall opposite to the first wall; the first limiting portion comprises a guide hole defined in the first wall, the guide hole is located between the first end and the second end;
the second base body is slidably disposed between the first wall and the second wall, the second limiting portion comprises a stop member and an elastic member, the stop member is connected to the second base body via the elastic member;
when the blade is at the in-use position, under an action of the elastic member, the stop member is at least partially received in the guide hole and abuts against a hole wall of the guide hole;
the stop member, when being pressed in a direction toward the second wall, is disengaged from the guide hole to cause the elastic member to be stressed to be in an elastic potential energy loaded state; and
when the blade is at the replacement position, the stop member is disposed between the guide hole and the first end.

5. The scraper according to claim 3, wherein:
the first base body comprises a first wall and a second wall opposite to the first wall; the first limiting portion comprises a guide hole defined in the first wall, the guide hole is located between the first end and the second end;
the second base body is slidably disposed between the first wall and the second wall, the second limiting portion comprises a stop member and an elastic member; one end of the elastic member is connected to the second base body, and the other end of the elastic member abuts against the second wall, so as to enable the second base body to be disposed closer to the first wall than the second wall or to be in contact with the first wall;
when the blade is at the in-use position, under an action of the elastic member, the stop member is at least partially received in the guide hole and abuts against a hole wall of the guide hole; and
the stop member, when being pressed, is disengaged from the guide hole, and the second base body approaches the second wall to cause the elastic member to be stressed to be in an elastic potential energy loaded state; and when the blade is at the replacement position, the stop member is disposed between the guide hole and the first end.

6. The scraper according to claim 5, wherein:
the guide hole is elongated and extends along a sliding direction of the second base body, the first limiting portion comprises a first stop surface arranged in the guide hole, the first stop surface is disposed on a hole wall of the guide hole near the first end;
the scraper further comprises a button portion protruding from the second base body, the button portion and the stop member are spaced apart from each other along the sliding direction or are connected to each other, the button portion is at least partially received in the guide hole and is capable of sliding along an extension direction of the guide hole; when the button portion is pressed, the stop member is capable of being disengaged from the guide hole, the second base body approaches the second wall, and the elastic member is stressed to be in the elastic potential energy loaded state;
when the blade is at the retracted position, the stop member is at least partially received in the guide hole and is spaced apart from the first stop surface;
when the blade is at the in-use position, the stop member abuts against the first stop surface; and
when the blade is at the replacement position, the button portion abuts against the first stop surface.

7. The scraper according to claim 4, wherein:
the first base body further comprises a clearance groove recessed in the first wall, the clearance groove is located between the guide hole and the first end; and
when the blade is at the replacement position, the stop member is received in the clearance groove.

8. The scraper according to claim 1, wherein:
the blade comprises a first positioning structure protruding from the blade body and a second positioning structure recessed in the blade body;
the first base body comprises a first wall and a second wall opposite to the first wall, the second base body is slidably disposed between the first wall and the second wall;
the second base body comprises a mounting portion; the mounting portion comprises a bearing surface, a first positioning groove recessed in the bearing surface, and a second positioning protrusion protruding from the bearing surface; in a sliding direction of the second base body, the first positioning groove is disposed between the second end and the second positioning protrusion;
the bearing surface and the first wall or the bearing surface and the second wall cooperatively clamp the blade body; the first positioning structure is engaged in the first positioning groove, the second positioning structure is engaged with the second positioning protrusion; when the blade is at the in-use position, the first positioning groove and the second positioning protrusion are both disposed between the first end and the second end and shielded by the first wall or the second wall; and
the blade is capable of being arranged at a replacement position at which the blade is capable of being replaced; when the blade is at the replacement position, the second positioning protrusion is not shielded by the first wall or the second wall.

9. The scraper according to claim 1, wherein:
the blade comprises a second positioning structure recessed in the blade body;
the first base body comprises a first wall and a second wall opposite to the first wall, the second base body is slidably disposed between the first wall and the second wall;
the second base body comprises a mounting portion; the mounting portion comprises a bearing surface and a second positioning protrusion protruding from the bearing surface;
the bearing surface and the first wall or the bearing surface and the second wall cooperatively clamp the blade body, the second positioning structure is engaged with the second positioning protrusion; when the blade is at the in-use position, the second positioning protrusion is disposed between the first end and the second end and is shielded by the first wall or the second wall; and
the blade is capable of being arranged at a replacement position at which the blade is capable of being replaced; when the blade is at the replacement position, the second positioning protrusion is not shielded by the first wall or the second wall.

10. The scraper according to claim 1, wherein:
the first base body comprises a first wall and a second wall opposite to the first wall in a thickness direction of the first base body; an installation cavity is formed between the first wall and the second wall, the installation cavity has a blade exit opening at the first end;
the first base body comprises a guide hole defined in the first wall; the guide hole communicates the installation cavity with an outside of the scraper; the guide hole is elongated and extends along a sliding direction of the second base body;
the second base body is slidably received in the installation cavity; the second base body comprises a button portion and a mounting portion; the button portion at least partially passes through the guide hole to be exposed via the guide hole; the mounting portion and the first wall or the mounting portion and the second wall cooperatively clamp the blade body; and
when the blade is at the retracted position, the cutting portion does not protrude from the blade exit opening; when the blade is at the in-use position, at least part of the cutting portion protrudes from the blade exit opening.

11. The scraper according to claim 10, wherein:
the first base body further comprises two side walls connected to the first wall and the second wall; and
the first base body further comprises an installation notch defined in the second wall; the installation notch is communicated with the installation cavity; an end of the installation notch near the blade exit opening is communicated with the blade exit opening; the button portion and the mounting portion are misaligned with each other in the thickness direction;
the mounting portion is at least partially received in the installation notch, and the mounting portion and the first wall cooperatively clamp the blade.

12. The scraper according to claim 11, wherein the first wall, the second wall and the two side walls are integrally formed with each other.

13. The scraper according to claim 12, wherein:
the first base body comprises a first limiting structure arranged on at least one of the two side walls, and the second base body comprises a second limiting structure arranged on the mounting portion; and
the first limiting structure and the second limiting structure are slidably engaged with each other to limit the mounting portion from disengaging from the installation notch in the thickness direction.

14. The scraper according to claim 13, wherein one of the first limiting structure and the second limiting structure is a limiting groove extending along the sliding direction, and the other one of the first limiting structure and the second limiting structure is a limiting protrusion.

15. The scraper according to claim 13, wherein:
the first limiting structure comprises a limiting groove extending along the sliding direction of the second base body, the second limiting structure comprises a limiting protrusion, the limiting protrusion is slidably received in the limiting groove;
the limiting protrusion is arranged with an inclined surface;
the inclined surface is configured to guide the limiting protrusion to enter the limiting groove when the limiting protrusion is engaged into the limiting groove from the installation notch in the thickness direction; and/or the inclined surface is configured to guide the limiting protrusion to enter the limiting groove when the limiting protrusion is engaged into the limiting groove from the blade exit opening in the sliding direction.

16. The scraper according to claim 15, wherein:
the limiting groove comprises a first limiting surface, the first limiting surface is located at an end of the limiting groove near the blade exit opening;
the first limiting surface is substantially perpendicular to the first wall;
the limiting protrusion is capable of abutting against the first limiting surface to limit the limiting protrusion from disengaging from the limiting groove in the sliding direction.

17. The scraper according to claim 11, wherein:
the guide hole extends in a direction toward the blade exit opening; and
a projection of the guide hole onto a first projection plane and a projection of the installation notch onto the first projection plane at least partially overlap with each other; the f irst projection plane is a plane perpendicular to the thickness direction.
